(19) United States
(12) Patent Application Publication
(10) Pub. No.: US 2024/0386085 A1
(43) Pub. Date: Nov. 21, 2024

(54) CONTEXT SWITCHING FROM REALITIES TO ACHIEVE ACCESS TO SPACES

(71) Applicant: INTERNATIONAL BUSINESS MACHINES CORPORATION, ARMONK, NY (US)

(72) Inventors: Rodolfo Lopez, Austin, TX (US); Mauro Marzorati, Lutz, FL (US); Jeremy R. Fox, Georgetown, TX (US); Carolina Garcia Delgado, Zapopan (MX)

(21) Appl. No.: 18/319,288

(22) Filed: May 17, 2023

(51) Int. Cl. G06F 21/32

(52) U.S. Cl. CPC G06F 21/32

(57) ABSTRACT

A method, computer system, and a computer program product are provided for authenticating a user. An image of a skin portion of the user is obtained. One or more landmarks are identified from the image obtained. The landmark includes at least one skin anomaly. Each identified landmark is analyzed at least with respect to location, form, dimensions and distances between landmarks and body parts. A unique signal is generated based on the identification and analysis of one or more landmarks. The unique signal is then stored for authentication of the user.

### BACKGROUND

The present invention relates generally to the field of data management and authentication, and more particularly to techniques for providing user access through context switching in a metaverse environment.

The ascendance of digital technologies continues to grow at a steady pace especially in metaverse environments. Metaverse, may be considered an iteration of a computing environment (the Internet, the cloud etc.) that has been facilitated by the virtual reality (VR) or augmented reality (AR). Metaverse provides an immersive three-dimensional realm that may be shared with many users. The concept of metaverse, some argue, has been developed through science fiction. However, the advances of technology have allowed metaverse to no longer be a hypothetical iteration.

Metaverse spans many digital platforms and may merge with the physical world (reality). The metaverse has been increasingly blurring the line between the digital worlds and the physical world (reality). Currently, many companies have been investing heavily in developing technologies that enable a workable metaverse environment.

### SUMMARY

Embodiments of the present invention disclose a method, computer system, and a computer program product for authenticating a user. An image of a skin portion of the user is obtained. One or more landmarks are identified from the image obtained using the image of the skin portion. The landmark includes at least one skin anomaly. Each identified landmark is analyzed at least with respect to location, form, dimensions and distances between each other and body parts. A unique signal is generated based on the identification and analysis the one or more landmarks. This unique signal is then stored and used for authenticating the user.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment, according to at least one embodiment;

FIG. 2 provides an operational flowchart used for an authentication technique. according to one embodiment; and

FIG. 3 is a block diagram of an example as provided by the embodiment of FIG. 2.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

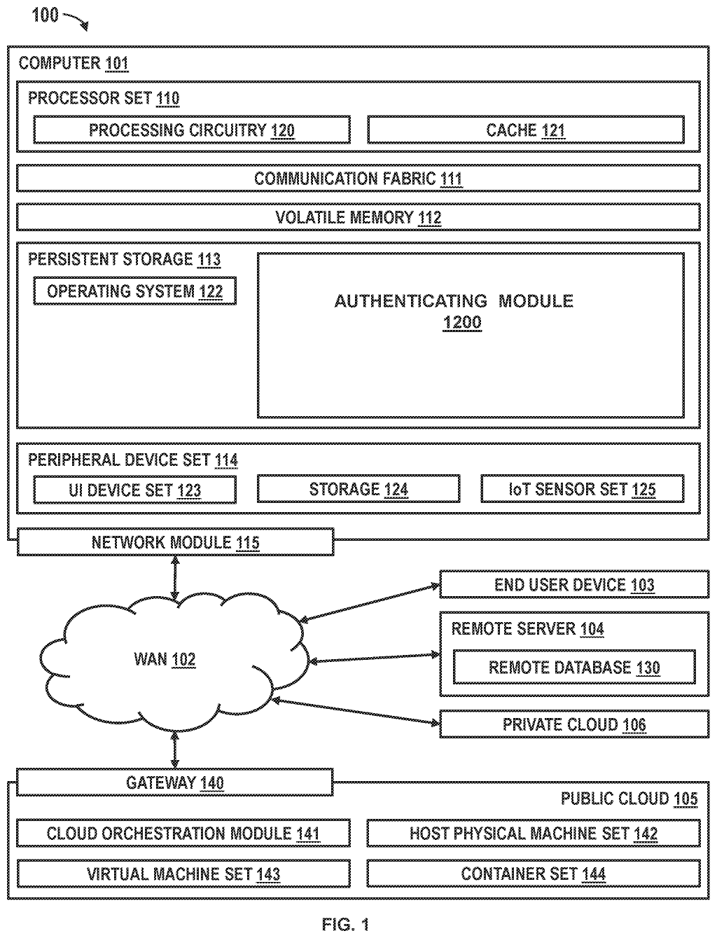

FIG. 1 provides a block diagram of a computing environment 100. The computing environment 100 contains an example of an environment for the execution of at least some of the computer code involved in performing the inventive methods, such as code change differentiator which is capable of an authentication module (1200). In addition to this block 1200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 1200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 1200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Technological companies may no longer view the metaverse as a hypothetical or futuristic supposition but as an emerging reality. There may be a transition period for the adaptation of these technologies into everyday activities. Currently, steps toward adaptation seem to be moving forward at a steady pace. A transition period may be needed in most cases where Augmented Reality (AR) and Metaverse (VR) will require context switching between the two environments. One issue that presents itself as a challenge in this area, may be seamless access/authentication during transitioning from one to the other environment. For example, in a metaverse environment, work force locations may have their own workrooms, meeting rooms, and other similar places for private or alternatively general conferences. These spaces may need to be created in a manner where workers can collaborate virtually, have a private meeting, access specific benefits, or accommodate a pay-per access event. A person may need to reach different spaces, however, depending on the user's needs, each of these spaces, may require different levels of security and authentication access.

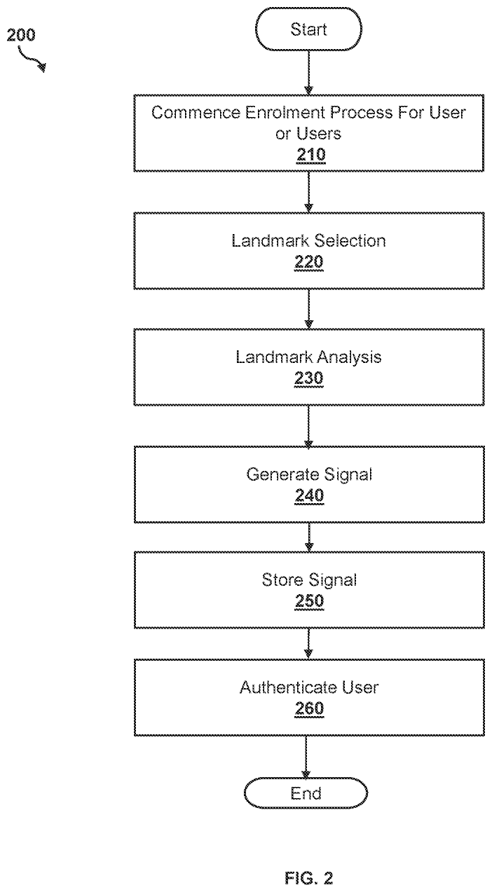

In many circumstances, the metaverse applies its own digital authentication and validation methods. However, there may still exist areas of vulnerability. For example, it may be possible for an impostor to take one's avatar and bypass into private access/pay-per access events as if it were meant for the human's own avatar. These opportunities do not exist in the real world but preventing digital access in the metaverse may be more difficult. The challenge may be to ensure that the digital validation and the actual real-life validation of human beings that need to access the space can align. In other words, the actual human beings (as appearing in the form of avatar) must truly be authorized to access the space. An impostor should not be permitted to hide behind an avatar and enter an unauthorized space. Such a solution may be provided by process 200 as illustrated in one embodiment according to FIG. 2.

FIG. 2 provides a flowchart illustration of an authentication technique. Process 200 as shown prevents a breach of the authentication required to access a space. In Step 210, an enrollment process commences the authentication process. During the enrollment, steps may be taken to establish one or more user's identity that will be used ultimately for future authentications in one or more spaces. In one embodiment, this may entail a setup process where before interaction with the system (a VR system in one embodiment), the user will engage in a setup process such as using an augmented reality (AR) mechanism. To set up the process, as per one embodiment, the user may use a computer, a personal or mobile device or any gadget with a gadget with camera (preferably video camera) capabilities. In addition to laptops and computers, other examples may include smart devices such as wearables (smart watches, rings, pens, belts etc.). The image can be a simple photographic image capture, or part of a recorded video or a live stream.

In Step 220, the image may be analyzed, and any anomalies (hereinafter landmarks) may be identified. This can include skin tags, scars, freckles, moles, tattoos, or other features. In one embodiment, during the setup process, the user may select a particular area that can be used as part of the authentication process. It can also be selected by default or by an artificial intelligence (AI) machine using machine learning (ML) models (some examples can include but are not limited to text to image models, convolutional neural networks (CNN) or other machine language algorithms that allow image processing etc). When the user activates the camera (on the gadget etc.), the user (or an AI using one or more machine language engines) will select the areas that will be used for the authentication process. In one embodiment, this process will be associated with an augmented reality (AR) system.

In Step 230, the identified landmark(s) may be analyzed. The analysis can include the location of each landmark with respect to another landmark and/or other areas such as a user's body parts. In addition, specifics about the landmark such as its form, shape and dimensions and angles of its connection may be analyzed in three dimensions.

In one embodiment, the landmark locations may be assessed and marked accordingly. For example, it may first be determined what part of the user's body has been captured in the image (neck, left ear, front right side, lower left leg, abdomen etc.). Then the associated item or items forming the landmark may be carefully determined and marked. This may solve the problem of facial recognition issues being compromised. In one embodiment, the determination of the landmark has several components. For example, in one embodiment, there may be three or more different and separate analysis relating to each landmark. The first may be the analysis of the actual location each landmark or item (tattoo, scar, freckles, etc.). This location will be identified based on a variety of factors such as the identified body part (e.g., near of the right ear, right hand, left hand, etc.).

The second analysis may involve the type of the landmark or item (tattoo, scar, freckles, etc.). In one embodiment, this may further involve the analysis and recording of the form and dimensions of the landmark (height, width, how it may be connected or embedded, degrees of tilt etc.).

The next analysis that may be involved may be that of distances between a body part and the landmark or item (tattoo, scar, freckles, etc.). This step will be able to identify the distance in X, Y, and degrees of the item versus the body part.

In Step 240, a signal may be generated with the information relating to each landmark. In one embodiment, a unique signal may be generated according to the previous step's analysis.

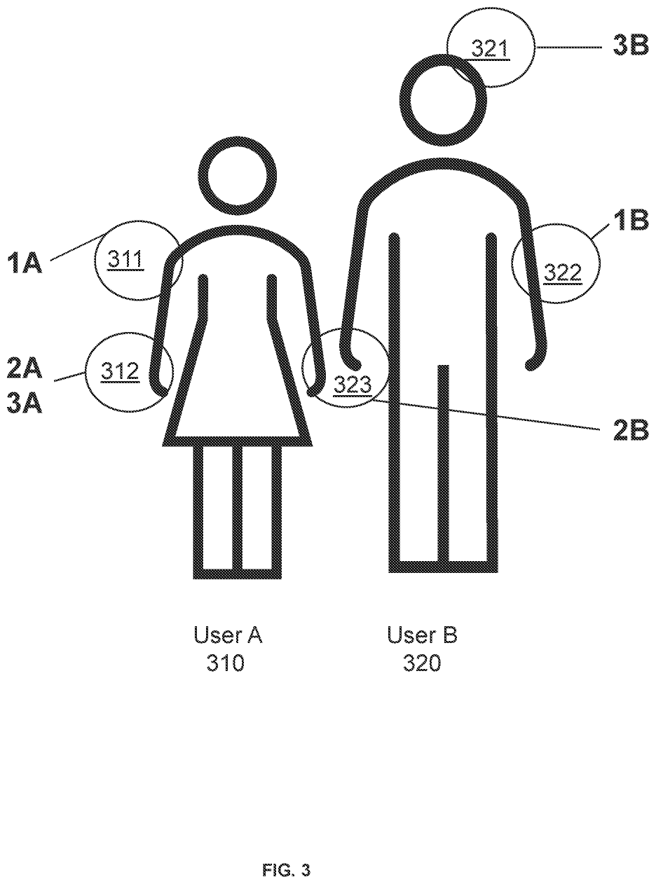

This signal may be used to identify distances, forms/figures (pictures of the items) and degrees of connection to the skin and between the landmarks etc.). This signal will be used for authentication and will be associated with the user (such as in a user profile, database etc.). A more detailed example of this will be provided in conjunction with the scenario of FIG. 3.

In one embodiment, there may be more than one user and the same process may be

conducted for each one. Alternatively, the signal generated may include a combination of several users or a combination of landmarks for one or more users depending on the use and authentication needed (group vs individual). The unique signal can be used by a user to gain access and move freely in the virtual world (through authentication). The unique signal may be used for the authentication process, may also be generated as to include a combination of landmarks/items for a particular user or even be created by a combination of landmarks shared between a plurality of users.

In Step 250, the generated signal can be stored in a database. In one embodiment, the signal can be associated with one or more user or group profiles and be used in association with this authentication exclusively or otherwise. It can also provide an associated level of security that may allow authentication in some instances but not in all instances depending on security level allowances. The location of database can be varied. It can be part of a computer network or cloud, be remotely located or be local and stored on a laptop, desktop, device, or other means in different alternate embodiments.

In Step 260, an authentication step may be conducted to allow access or deny access to a user trying to enter an environment or a space. In one embodiment, the user (or users) may be authenticated by comparing the stored/generated signal and a current status (in person, by image etc.) of a user or users. An authentication module may be used to grant the user (person) access to the computer system, or to a space/environment based on current information related to the user matching the information generated during the enrollment process. In this way, every time the user accesses a particular space that requires authentication space, the information may be retrieved (such as from the database) and used for comparison purposes to grant or deny access to a space or a computer system. The current status of the user may be obtained live or via an image captured as a photo, video, etc., to allow the user access to a particular space or environment/system (such as at the onset of signing on or any point where a different security status may be required).

In a preferred embodiment, the enrollment process (Step 210) may be enhanced to provide numerical sequencing to the (registered) landmarks for a given user. This may include repetition. For example, in one scenario, the person's (user's) left knee may be used twice in a row before returning to the neck/shoulder area landmark. When authentication may be needed, during the authentication process (Step 260) the system will accept only the N-th landmark that may be active for the current authentication attempt. Should the supplicant provide an otherwise validated landmark in the wrong sequence, all sequences may be removed, and the user must reset the sequence, similar to the enrollment process.

FIG. 3 provides a block diagram of an example to ease understanding. This provides only one example and in alternate embodiments other scenarios may be provided. In FIG. 3, two users have been shown and referenced as User A (310) and User B (320). User A has a mole on her shoulder indicated by reference numerals 311 and a tattoo on her hand indicated by reference numerals 312. User B (320) has a scar on his temple indicated by reference numerals 321, a scar on his elbow indicated by reference numerals 322 and a skin tag on his hand indicated by reference numerals 323.

The authenticated sequence provided for User A has been indicated as 1A (311), and 2A and 3A (312). The sequence generated has 1A as a single item but sequence 2A and 3A (312) are a repetition pattern. Similarly, for User B (320), the pattern is 3B associated with 321, 1B, associated with 322 and 2B associated with 323. The sequence here has no repetition but they are disposed in an out of order manner to create a unique sequence (instead of 1B, 2B and 3B sequence they are 3B, 1B and 2B).

The signal generated in this scenario will include the sequence provided above but also specifics about each item of the sequence. So for User A (310) in this scenario, the following can be part of the unique signal generated: 1) the mole 311—the location of the mole (on right or left shoulder), the shape of the mole, its border shape, its color, if it is flat or raised and an angle of attachment if raised; 2) tattoo on hand (312)—the design, the length and width, the color (as well as faded or not), specific location and distance from body parts (fingers, which fingers, wrist, left or right side of the body, face up or down etc.) The same is provided for User B (320). The sequence is combined with information about the location and shape of the scar on the temple (321), its color and borders and the side of the head where the scar is provided as well as its distance from (for example) the eyebrow, the eye, the ear, the hairline etc. The same applies to the scar on the elbow 322. The skin tag 322 is also analyzed as with regard to its shape, location and distance to body parts and whether it is flushed with the skin or raised and if raised its angle of attachment and any three dimensional characteristics.

The techniques suggested may provide many benefits. For example, a user may still access and authenticate the system without having to worry about moving from on system into another (within real or metaverse environment). The technique may also provide a seamless flow between the metaverse and other environments and allows for the interactions to continue without stopping user activities. The technique may also allow for hybrid interactions to flow while switching among the metaverse and other environments such as the real-world environments (e.g., context switching). In one embodiment, some avatars may have their backend person at home so they cannot validate other avatars in a private conference. This may ensure validation has been done by the platform and not by them. Application of a reality context switching method within AR/Metaverse may ensure seamless interaction.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of authenticating a user, comprising:
obtaining an image of a skin portion of a user's body;
identifying one or more landmarks from said image associated with said skin portion of said user, wherein a landmark includes at least one skin anomaly;
analyzing said one or more identified landmarks at least with respect to location, form, dimensions and distances between one or more body parts or one or more other landmarks;
generating a unique signal based on said identification and analysis of any of said one or more identified landmarks; and
storing said unique signal for authentication of said user.

2. The method of claim 1, further comprising associating said generated unique signal with said user in a user profile.

3. The method of claim 1, wherein there are a plurality of users and said unique signal includes a combination of several users or a combination between at least two different landmarks associated with at least one user.

4. The method of claim 1, wherein there are a plurality of landmarks identified for said user and said unique signal is provided by generating a numerical sequence of said one or more identified landmarks.

5. The method of claim 4, wherein said numerical sequence further comprises providing a sequence of each one or more identified landmark presentation in a particular order having at least one repetition.

6. The method of claim 4, wherein said user will not be authenticated unless said numerical sequence is provided.

7. The method of claim 1, wherein analysis of a landmark location includes identification of said one or more landmark in relation to distance to a user body part.

8. The method of claim 7, wherein said distance is measured in three dimensions and distances between any other identified landmark(s) in proximity as identified.

9. The method of claim 7, wherein said distance is measured in three dimensions and distances between each proximal other body parts as identified.

10. The method of claim 1, wherein analysis of a form and dimensions of said landmark includes said landmark(s) three dimensional measurements including any angles.

11. The method of claim 10, wherein said dimensions include its measurements in all X, Y and Z directions and any angles of attachments of a raised landmark to a body part.

12. The method of claim 1, wherein said image is obtained from a video or a live streaming broadcast.

13. The method of claim 1, wherein said image is obtained from a smart device.

14. The method of claim 4, wherein said unique sequence is stored and associated to said user, further comprising authenticating said user by comparing a user's current image with that of said previously stored sequence connected to said user.

15. The method of claim 1, wherein said user is authenticated when entering a virtual environment or changing from one virtual environment into another virtual environment or into a real environment.

16. A computer system for authenticating a user, comprising:
one or more processors, one or more computer-readable memories and one or more computer-readable storage media;
program instructions, stored on at least one of the one or more storage media for execution by at least one of the one or more processors via at least one of the one or more memories, to obtain an image of a skin portion of a user's body;
program instructions, stored on at least one of the one or more storage media for execution by at least one of the one or more processors via at least one of the one or more memories, to identify one or more landmarks from said image associated with said skin portion of said user, wherein any landmark includes at least one skin anomaly;
program instructions, stored on at least one of the one or more storage media for execution by at least one of the one or more processors via at least one of the one or more memories, to analyze said one or more identified landmarks at least with respect to location, form, dimensions and distances between a user's body part(s) or one or more other landmarks;
program instructions, stored on at least one of the one or more storage media for execution by at least one of the one or more processors via at least one of the one or more memories, to generate a unique signal based on identification and analysis of any identified one or more landmarks; and
program instructions, stored on at least one of the one or more storage media for execution by at least one of the one or more processors via at least one of the one or more memories, to store said unique signal for authenticating said user.

17. The computer system of claim 16, wherein said there are a plurality of users and said unique signal can include a combination between several users or a combination between at least two different landmarks associated with said user.

18. The computer system of claim 16, wherein there are a plurality of landmarks identified and said unique signal is provided by generating a numerical sequence of said one or more landmarks.

19. The computer system of claim 18, wherein said unique sequence is stored and associated to said user, further comprising authenticating said user by comparing a user's current image with that of a previously stored sequence connected to said user.

20. A computer program product for authenticating a user, the computer program product comprising:
one or more computer readable storage media;
program instructions, stored on at least one of the one or more storage media for execution by at least one of the one or more processors via at least one of the one or more memories, to obtain an image of a skin portion of a user's body;
program instructions, stored on at least one of the one or more storage media for execution by at least one of the one or more processors via at least one of the one or more memories, to obtain an image of a skin portion of a user's body;
program instructions, stored on at least one of the one or more storage media for execution by at least one of the one or more processors via at least one of the one or more memories, to identify one or more landmarks from said image associated with said skin portion of said user, wherein any landmark includes at least one skin anomaly;
program instructions, stored on at least one of the one or more storage media for execution by at least one of the one or more processors via at least one of the one or more memories, to analyze any identified landmark(s) at least with respect to location, form, dimensions and distances between a user's body part(s) or one or more other landmarks;
program instructions, stored on at least one of the one or more storage media for execution by at least one of the one or more processors via at least one of the one or more memories, to generate a unique signal based on identification and analysis of any of said one or more landmarks; and
program instructions, stored on at least one of the one or more storage media for execution by at least one of the one or more processors via at least one of the one or more memories, to store said unique signal for authenticating said user.
